(19) United States
(12) Patent Application Publication
(10) Pub. No.: US 2011/0230188 A1
(43) Pub. Date: Sep. 22, 2011

(54) Methods and Network Nodes in a Mobile Communication Network

(76) Inventor: Sven Gemski, Solna (SE)

(21) Appl. No.: 12/987,546

(22) Filed: Jan. 10, 2011

Related U.S. Application Data
(60) Provisional application No. 61/315,056, filed on Mar. 18, 2010.

(30) Foreign Application Priority Data
Jan. 3, 2011 (SE) PCT/SE2011/050001

(51) Int. Cl. H04W 40/02

(52) U.S. Cl. 455/435.1

(57) ABSTRACT

In accordance with embodiments of the present invention, a list of preferred Public Land Mobile Networks (PLMNs) is used by a radio access network (RAN) node for distributing subscriber registrations to respective core network (CN) nodes and, notably, is expanded to also include the Mobile Subscriber Identity Number (MSIN) of subscribers. At least one bit of the MSIN, starting from the most significant bit, is interpreted to indicate the CN node to which a subscriber registration is to be routed. In this way the granularity of the preferred PLMN list is increased and it is thereby possible to steer subscriber registrations to specific core network nodes (e.g., Mobile Switching Centers and/or Serving GPRS Support Nodes) within one CN network operator.

### RELATED APPLICATIONS

This application claims priority to U.S. Provisional Patent Application Ser. No. 61/315,056, filed 18 Mar. 2010, and International Patent Application No. PCT/SE2011/050001, filed 3 Jan. 2011, both of which are incorporated herein by reference in their entirety.

### TECHNICAL FIELD

The embodiments of the present invention relate to network nodes and methods thereof in a mobile communication network for steering subscriber registrations to a specific core network node, and in particular to core network node selection by using Multi Operator Core Network mechanisms.

### BACKGROUND

One feature in current 3G networks is that a radio access network (RAN) can be shared by a plurality of network operators while each operator has its own core network. This feature is referred to as Multi Operator Core Network (MOCN). As a larger part of the investment cost for deploying a mobile communication network relates to the radio access network part, the network operators can decrease their cost by sharing the radio access network with other operators.

In the existing networks for handling MOCN, a list of the preferred Public Land Mobile Network (PLMN) is used by the RAN node for distributing subscriber registrations to the respective core network. A preferred PLMN lists contain the PLMN identities of the network operators who are sharing the radio access network. The PLMN identities comprise a mobile country code (MCC) and a mobile network code (MNC) and a network operator is uniquely identified by a PLMN identity. The preferred PLMN lists can also contain the respective CN operator's main roaming partner's PLMN identities in case it is desired to not spread them out on all possible CN operators.

When a subscriber and terminal once has been registered with an Mobile Switching Center (MSC) and Serving GPRS Support Node (SGSN) it will be assigned a TMSI-NRI (Temporary Mobile Subscriber Identity-NRI) in the circuit switched domain and a P-TMSI-NRI (Packet Temporary Mobile Subscriber Identity-NRI) in the packet switched domain pointing at the specific MSC and SGSN. This TMSI-NRI and P-TMSI-NRI will route all coming signaling sessions, such as call attempts and Short Message Service's (SMS's) to the correct MSC and SGSN for the reminder of the subscribers staying in the RAN. This is according to MOCN standard behavior which is described further below.

The MOCN feature enabling routing of subscriber registrations to different core network operators, i.e. groups of Mobile Switching Centers (MSCs) and Serving GPRS Support Nodes (SGSNs), is based on the MCC and MNC of the subscriber. This means that it is not possible to route subscriber registrations between specific MSCs or SGSNs within one operator because all subscribers have the same identity (MCC-MNC) in this regard. Therefore, the PLMN identities of the preferred lists are not granular enough such that they can not be used for distributing subscribers between different MSCs and SGSNs of the core network within one network operator, when a common PLMN identity is used for all subscribers.

### SUMMARY

An object with embodiments of the present invention is to provide a solution for steering subscriber registrations to a certain core network node such that calls and other services then will be handled by this core network node.

This is achieved by expanding the preferred PLMN list to also include the whole or parts of the mobile subscriber identity number (MSIN) and by utilizing these bits originally intended for indicating a mobile subscriber identity number to indicate the CN node to which registrations of a certain subscriber should be routed. Each subscription is uniquely associated with an IMSI and the IMSI comprises a predefined number of bits for indicating a mobile country code (MCC), a predefined number of bits for indicating a mobile network code (MNC) indicating the operator of the subscriber, and a predefined number of bits indicating the MSIN, which is the subscriber's individual identity number.

Thus in accordance with embodiments of the present invention a predefined number of the MSIN bits are investigated to select which of the MSC (circuit switched traffic)/SGSN (packet switched traffic) that the subscriber registration should be routed to. The different CN nodes that the RAN nodes can select from may belong to the same network operator or different network operators.

According to a first aspect of embodiments of the present invention a method in a radio access network node for steering subscriber registrations to predefined core network nodes is provided. The radio access network node is configured to be connected to a plurality of core networks. In the method, an IMSI of a subscriber is received in connection with establishment of a subscriber registration for said subscriber. The IMSI comprises a predefined number of bits indicating country network and identity (referred to as MSIN) of the subscriber. The IMSI is analyzed by investigating the predefined number of bits indicating country and network of the subscriber and at least one of the predefined number of bits of the MSIN. A result of the investigation is mapped to a core network node to which the subscriber registration should be routed, and the subscriber registration is routed to the core network node.

According to a second aspect of embodiments of the present invention a radio access network node for steering subscriber registrations to predefined core network nodes is provided. The radio access network node is configured to be connected to a plurality of core networks and the radio access network node comprises and input/output section configured to receive an IMSI of a subscriber in connection with establishment of a registration for said subscriber. The IMSI comprises a predefined number of bits indicating country, network and identity (referred to as MSIN) of the subscriber. The radio access network node comprises a processor configured to analyze the IMSI by investigating the predefined number of bits indicating country and network of the subscriber and at least one of the predefined number of bits of the MSIN and to map a result of the investigation to a core network node to which the subscriber registration should be routed, and a router configured to route the subscriber registration to the core network node.

According to a third aspect of embodiments of the present invention a method in a core network node for steering subscriber registrations to a predefined core network node is provided. The core network node is configured to be connected to a radio access network node. In the method, an IMSI of a subscriber is received in connection with establishment of a subscriber registration for said subscriber. The IMSI comprises a predefined number of bits indicating country, network and identity referred to as the MSIN, of the subscriber. The IMSI is analyzed by investigating the predefined number of bits indicating country and network of the subscriber and at least one of the predefined number of bits of the MSIN. The result is mapped to a core network node which is an allowed core network node for the subscriber registration, and an accept message is sent to the radio access network node if the said core network node is the allowed core network node, else a reject message is sent to the radio access network node if said core network node is not the allowed core network node.

According to a fourth aspect of embodiments of the present invention a core network node for steering subscriber registrations to a predefined core network node is provided. The core network node is configured to be connected to a radio access network node and the core network node comprises an input/output section configured to receive an IMSI of a subscriber in connection with establishment of a subscriber registration for said subscriber. The IMSI comprises a predefined number of bits indicating country, network and identity (referred to as the MSIN) of the subscriber. The core network comprises a processor configured to analyze the IMSI by investigating the predefined number of bits indicating country and network of the subscriber and at least one of the predefined number of bits of the MSIN, and to map the result to a core network node which is an allowed core network node for the subscriber registration. The input/output section is further configured to send an accept message to the radio access network node if the said core network node is the allowed core network node, and to send a reject message to the radio access network node if said core network node is not the allowed core network node.

### BRIEF DESCRIPTION OF THE DRAWINGS

FIG. 1 illustrates the preferred PLMN list according to embodiments of the present invention.

FIG. 2 is a flowchart illustrating a method in the RAN node according to embodiments of the present invention.

FIG. 3 is a sequence diagrams showing embodiments of the present invention.

FIG. 4 is a flowchart illustrating a method in the CN node according to embodiments of the present invention.

FIGS. 5-6 illustrate different scenarios of the embodiments of the present invention.

FIG. 7 illustrates schematically a RAN according to embodiments of the present invention.

FIG. 8 illustrates schematically a CN node according to embodiments of the present invention.

### DETAILED DESCRIPTION

Those skilled in the art will appreciate that the means and functions explained herein below may be implemented using software functioning in conjunction with a programmed microprocessor or general purpose computer, and/or using an application specific integrated circuit (ASIC). It will also be appreciated that while the current embodiments are primarily described in the form of methods and devices, the embodiments may also be embodied in a computer program product as well as a system comprising a computer processor and a memory coupled to the processor, wherein the memory is encoded with one or more programs that may perform the functions disclosed herein.

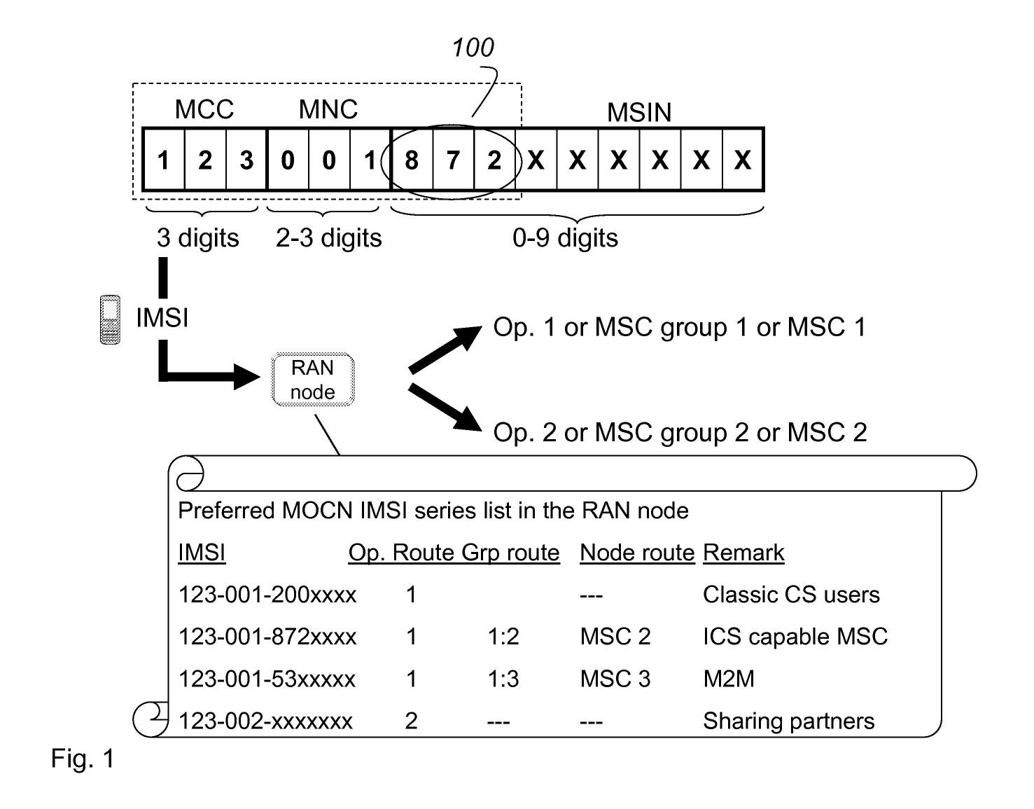

In accordance with embodiments of the present invention, a list of the preferred PLMNs which is used by the RAN node for distributing registrations from subscribers to the respective core network is expanded to also include the MSIN. At least one bit 100 of the MSIN, starting from the most significant bit, is reinterpreted to indicate the CN node as illustrated in FIG. 1. In this way the granularity of the preferred PLMN list is increased and it is thereby possible to steer subscriber registrations to specific MSC's and SGSN's within one CN network operator.

In the example of FIG. 1, the first three bits (exemplified by 872) are added to the MCC (exemplified by 123) and MNC (exemplified by 001) in order to form a routable number. Accordingly, the RAN node analyses the IMSI at this expanded level and finds that the specific series (exemplified 123+001+872) shall be routed to MSC 2 of operator 2.

Hence, in order to form the routable number, the first bit or any predefined number of the bits of the MSIN may be used in addition to the MCC and MNC. The number of bits of the MSIN to be included in this routing analysis is a configurable option.

It should be noted that the embodiments of the present invention also makes it possible to steer subscriber registrations between CN nodes belonging to the same network operator or between CN nodes belonging to different network operators. For example, subscriber registrations can be distributed between groups of MSC's and SGSN's within one network operator in case the MOCN feature is combined with the pooling concept (load sharing between multiple CN nodes).

The purpose to distribute the subscriber registrations may be for load sharing and resilience purposes. This implies that the risk for service outage due to node failure is reduced for subscribers in a geographical area are distributed between several CN nodes. If a CN node fails there are other nodes that can take over and serve the subscriber in the same geographical area.

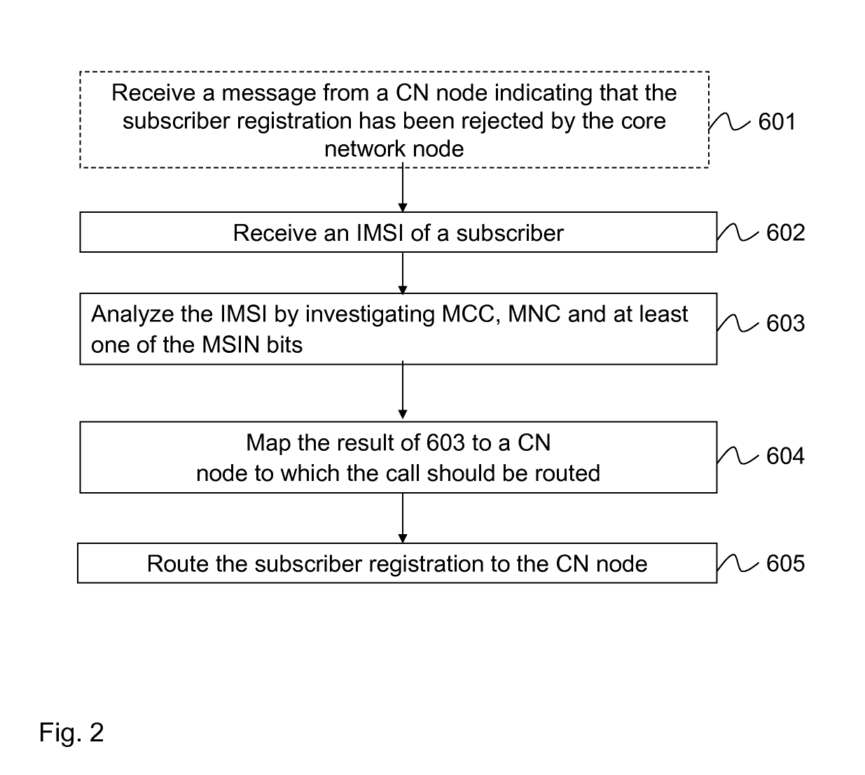

As illustrated in FIG. 2, a method in a radio access network node for steering subscriber registrations to predefined core network nodes is provided. The radio access network node is configured to be connected to a plurality of core networks.

The method may be triggered by receiving 601 a message from a core network node or the UE. The received message from the MSC may indicate that the registration for the subscriber has been rejected by the core network node and that predefined number of bits indicating country and network of the subscriber and at least one of the predefined number of bits of the MSIN should be investigated and the result of the investigation should be mapped to a core network node to which the registration should be routed.

Further, in the method, an IMSI of a subscriber is received 602 in connection with establishment of a subscriber registration for said subscriber, wherein the IMSI comprises a predefined number of bits indicating country (referred to as MCC) network (referred to as MNC) and identity also referred to as Mobile Subscriber Identity Number (MSIN) of the subscriber.

The IMSI is analyzed 603 by investigating the predefined number of bits indicating country and network of the subscriber and at least one of the predefined number of bits of the MSIN and a result of the investigation is mapped 604 to a core network node to which the subscriber registration should be routed. The subscriber registration is then routed 605 to the core network node.

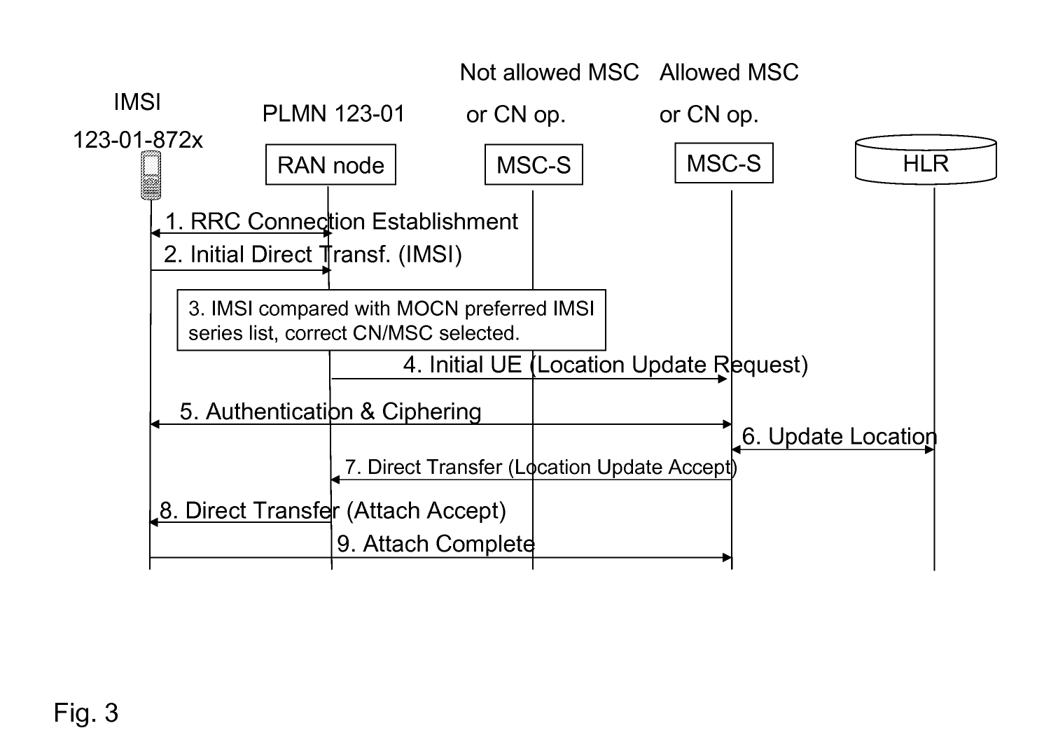

FIG. 3 is a sequence diagram showing a subscriber registration wherein the IMSI of the subscriber is used. In a first step 1 a Radio Resource Connection (RRC) is established. The subscriber terminals may include the IMSI directly when registering to the network in the second step 2 by an Initial Direct Transfer message (corresponding to step 602 of FIG. 2). Hence the RAN node receives the IMSI and can then analyze the IMSI in the third step 3 by investigating the predefined number of bits indicating country and network of the subscriber and at least one of the predefined number of bits of the MSIN (corresponding to step 603), and maps (corresponding to step 604) a result of the investigation to a core network node to which the subscriber registration should be routed and which is the allowed CN node. In this case the allowed CN node is indicated “Allowed MSC or CN op”. In the further steps 4-9 the subscriber registration is routed to the CN node (corresponding to step 605), which the RAN node has determined to be the allowed CN node to enable communication via the allowed CN node. Thus the UE can proceed with the attach procedure in steps 4-9 with the allowed CN node implying e.g. registration of necessary identities and location information in the allowed MSC and Home Location Register (HLR).

According to a further example, a Temporary Mobile Subscriber Identity (TMSI) may be used as subscriber identity when performing the subscriber registration. The TMSI is unknown to the network. In such case the RAN node does not know which MSC and SGSN or group of MSC's and SGSN's to route the registration to. The RAN node may then use a MOCN random weighted distribution mechanism and route the registration to a random MSC or SGSN. The MSC's and SGSN's which are selected by the random weighted distribution mechanism receive the IMSI and then evaluate the IMSI on the same level as the RAN nodes. That implies that the MSC or SGSN analyzes the IMSI by investigating MCC, MNC and a predefined number of bits of the MSIN, and maps the result of the investigation to a core network node to which the subscriber registration should be routed and which is the allowed CN node. If this CN node (MSC or SGSN) is the allowed CN node it accepts the registration, otherwise it rejects the registration.

As the CN node selected by the random weighted distribution mechanism may be an unallowed CN node, a new reject cause code for the standardized MOCN redirect message may be added as an option. Any suitable reject cause code can be (mis)used for the purpose of informing the RAN node that it must do an analysis of the IMSI by investigating the MCC, MNC and at least one of the MSIN bits.

The RAN node then uses the IMSI by investigating the MCC, MNC and at least one of the MSIN bits to conclude which MSC (and SGSN) or group of MSC's (and SGSN's) to route the registration to.

When a subscriber and terminal once has been registered with an MSC and SGSN it will be assigned a TMSI-NRI (CS domain) and P-TMSI-NRI (PS domain) pointing at the specific MSC and SGSN. This TMSI-NRI and P-TMSI-NRI will route all coming signaling sessions to the correct MSC and SGSN for the reminder of the subscribers staying in the RAN. This is according to MOCN standard behavior.

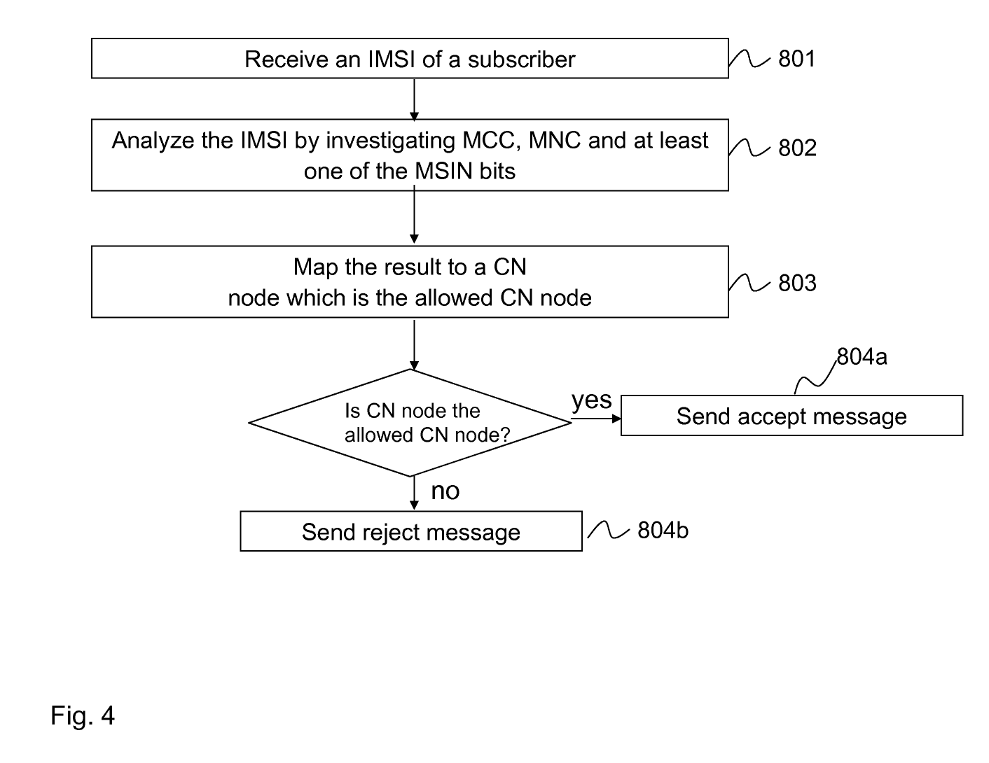

Thus as illustrated in the flowchart of FIG. 4, a method in a core network node for steering subscriber registrations to a predefined core network node is provided. The CN node is configured to be connected to a radio access network node. In the method, an IMSI of a subscriber is received 801 in connection with establishment of a subscriber registration for said subscriber, wherein the IMSI comprises a predefined number of bits indicating country (referred to as MCC), network (referred to as MNC), and identity, (referred to as MSIN) of the subscriber. The CN node then analyzes 802 the IMSI by investigating the predefined number of bits indicating country and network of the subscriber and at least one of the predefined number of bits of the MSIN, and maps 803 a result of the investigation to a core network node which is an allowed core network node for the subscriber registration. Further, an accept message is sent 804a to the radio access network node if the said core network node is the allowed core network node. Otherwise, a reject message is sent 804b to the radio access network node if said core network node is not the allowed core network node.

According to an embodiment, the reject message further comprises an indication that the predefined number of bits indicating country and network of the subscriber and at least one of the predefined number of bits of the MSIN should be investigated and the result of the investigation should be mapped to a core network node to which the registration should be routed.

The embodiments of the present invention may be used, as described above, for steering subscriber registrations to specific MSCs or SGSNs within one CN operator or within more operators sharing PLMN identity. In the following this is exemplified by describing three different scenarios.

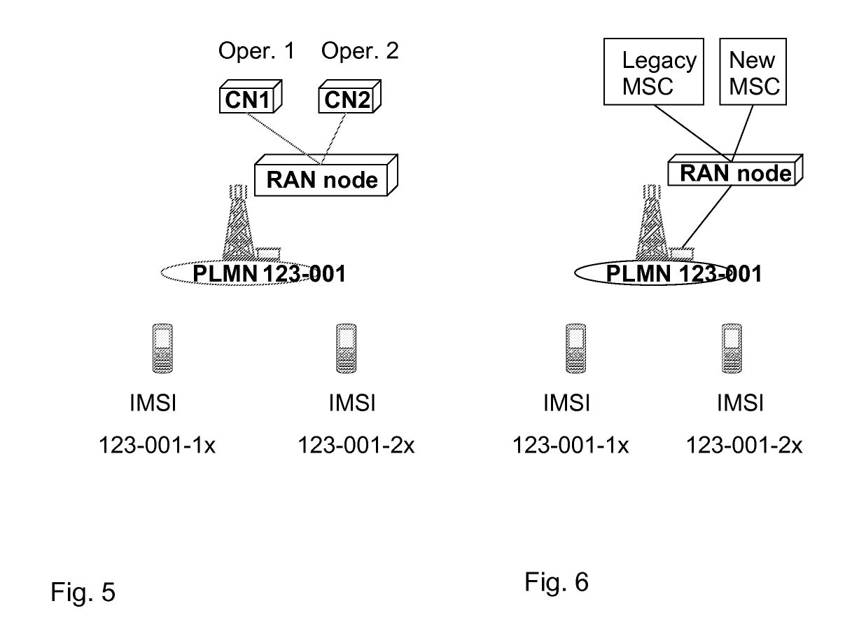

In a first scenario, two or more network operators are using a common PLMN identity (PLMN 123-001) for the RAN and their IMSI series which is illustrated in FIG. 5. In this scenario, the embodiments of the present invention enable steering of subscriber registrations between CN nodes (CN1 and CN2) within different operator networks (Operator 1 and Operator 2) having a common PLMN identity, which is also referred to as MOCN sharing. The reasons for this setup with using a common PLMN identity and IMSI series can be that one or more of the MOCN sharing partners do not have access to an own PLMN identity, E.g. for Mobile Virtual Network Operators (MVNO).

The MOCN sharing partners may want to reuse an existing IMSI series in order to gain immediate access to international roaming partners. In this way it is possible to reuse existing roaming agreements, since considerable efforts are required to set up roaming agreements with a new operator and a new PLMN identity.

Government agencies and authorities may want to use an existing operator's RAN and build an own separate CN on top of it for security reasons. This government CN can then be built in a cost efficient way even for a small group of users.

In a second scenario, the embodiments of the present invention can be used where only certain CN nodes within the same operator are upgraded with new functionality. In FIG. 6, the CN node with upgraded new functionality is indicated as New MSC and the CN node without upgraded new functionality is indicated as Legacy MSC. This implies that subscriber registrations can be steered to CN nodes depending on the functionality of the CN nodes and the capability of the subscriber terminal as shown in FIG. 6. I.e. registrations of subscribers having terminals with new functionalities can be distributed to upgraded CN nodes while registrations of subscribers having legacy terminals can be distributed to legacy CN nodes. Thus a big challenge for many network operators is how to introduce new services and features in networks where it will be extremely costly to upgrade or swap all the existing CN nodes. The embodiments here enable a simplification and workaround for this problem by introducing MOCN.

The main new interworking features which cannot be supported by the legacy core networks are, Session Initiation Protocol (SIP) and SIP-I for interconnecting to IP Multimedia Subsystem (IMS) and IP based networks, CS Fallback for handling combined Long Term Evolution (LTE) roaming and CS voice subscriptions, SRVCC (Single Radio Voice Call Continuity) for handover between LTE and GSM/WCDMA with MMTel (Multimedia Telephony) subscriptions, ICS (IMS Centralized Services) for MMTel usage in the GSM/WCDMA domain.

By using the embodiments, the new CN nodes can then be gradually expanded in capacity and numbers over time as the traffic grows towards e.g. the SAE and IMS domains. The legacy CN nodes can then be swapped out in a controlled way without requiring an unrealistic investment before the new services can be activated.

In a third scenario, CN nodes may be dedicated to machine-to-machine (M2M) communication. Since the characteristics in terms of user and mobility pattern of M2M communication differ from subscriber-to-subscriber communication, it may be advantageous to have certain dedicated CN nodes for the M2M communication.

The number of M2M devices such as alarms and different kind of indicators are expected to grow drastically over the coming few years. Analysts predict that more than 50 billion M2M devices will be deployed using mobile access. Many of these M2M devices use classic CS based SMS service and GPRS for the communication with the respective application.

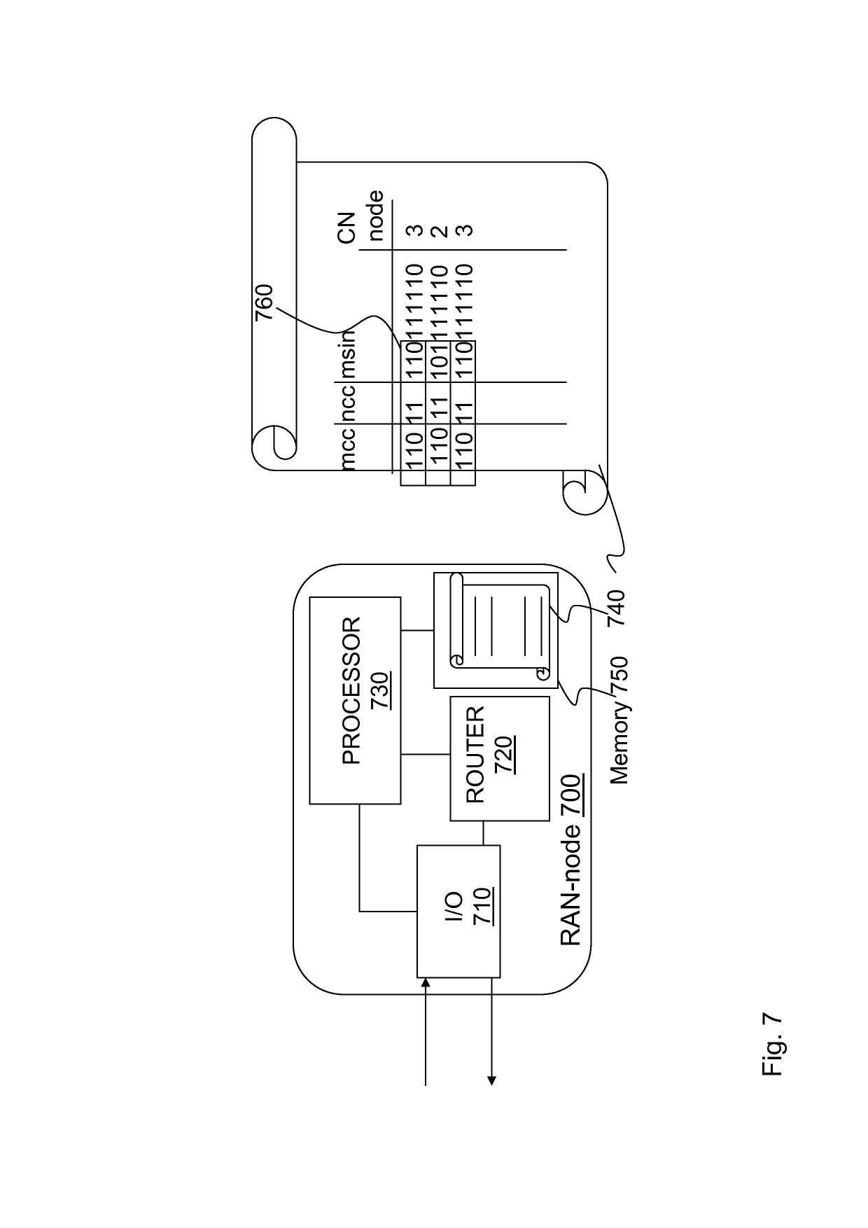

Turning now to FIG. 7 showing schematically a RAN node 700 for steering subscriber registrations to predefined core network nodes. The RAN node 700 is configured to be connected to a plurality of core networks. The RAN node comprises an input/output section 710 configured to receive an IMSI of a subscriber in connection with establishment of a registration for said subscriber, wherein the IMSI comprises a predefined number of bits indicating country (referred to as MCC), network (referred to as MNC), and identity, (referred to as MSIN) 760 of the subscriber. A processor 730 is configured to analyze the IMSI by investigating the predefined number of bits indicating country and network of the subscriber and at least one of the predefined number of bits of the MSIN 760 and to map a result 760 of the investigation to a CN node to which the subscriber registration should be routed, wherein a list 740 comprising the mapping stored in a memory 750 may be used for this purpose. The RAN node 700 further comprises a router 720 configured to route the subscriber registration to the CN node.

According to an embodiment, the input/output section 710 is further configured to receive a message from a core network node indicating that the registration for the subscriber has been rejected by the core network node, whereby the processor 730 is configured to, based on the message, interpret that the predefined number of bits of the MSIN should be investigated and that the predefined number of bits of the MSIN should be mapped to a core network node to which the subscriber registration should be routed.

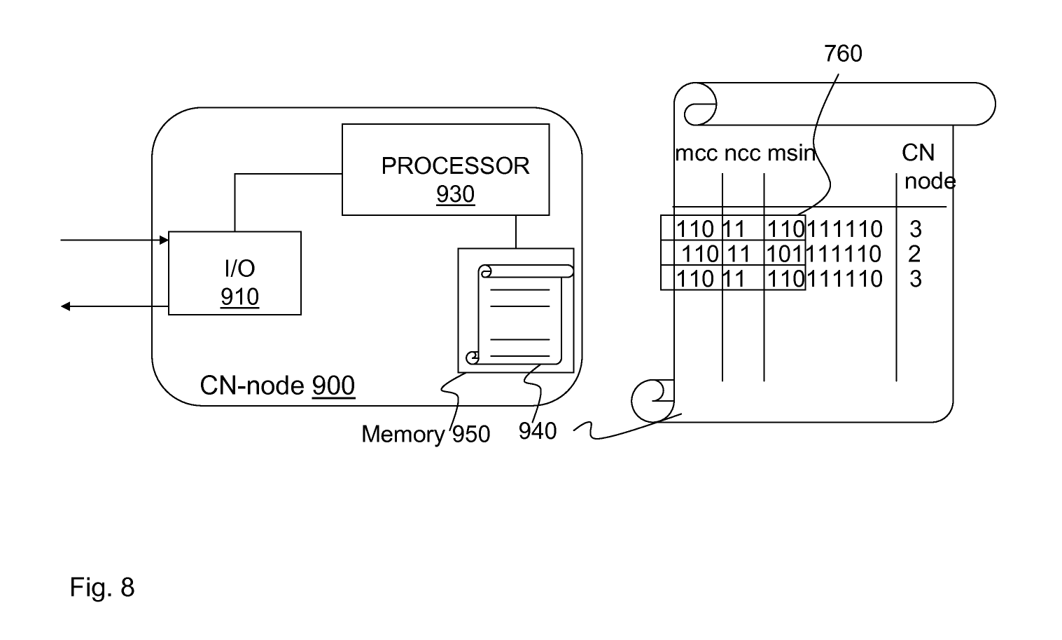

As illustrated in FIG. 8, a CN node 900 for steering subscriber registrations to a predefined core network node is schematically illustrated. The CN node 900 is configured to be connected to a radio access network node. The CN node 900 comprises an input/output section 910 configured to receive an IMSI of a subscriber in connection with establishment of a subscriber registration for said subscriber. The IMSI comprises a predefined number of bits indicating country and network of the subscriber and a predefined number of bits indicating a MSIN. The CN node further comprises a processor 930 configured to analyze the IMSI by investigating the predefined number of bits indicating country and network of the subscriber and at least one of the predefined number of bits of the MSIN 760, and to map a result 760 of the investigation to a core network node which is an allowed core network node for the subscriber registration. A list 940 comprising the mapping stored in a memory 950 may be used for this purpose. Moreover, the input/output section 910 is further configured to send an accept message to the radio access network node if the said core network node is the allowed core network node, and to send a reject message to the radio access network node if said core network node is not the allowed core network node.

What is claimed is:

1. A method in a radio access network node for steering subscriber registrations to predefined core network nodes, wherein the radio access network node is configured to connect to a plurality of core networks, and wherein the method comprises:
receiving an International Mobile Subscriber Identity (IMSI) of a subscriber in connection with establishment of a subscriber registration for said subscriber, wherein the IMSI comprises a predefined number of bits indicating a country, a network, and a Mobile Subscriber Identity Number (MSIN) of the subscriber,
analyzing the IMSI by investigating the bits indicating the country and network of the subscriber and at least one of the bits indicating the MSIN of the subscriber,
mapping a result of said investigation to a core network node to which the subscriber registration should be routed, and
routing the subscriber registration to that core network node.

2. The method according to claim 1, further comprising receiving a message from a core network node indicating that the subscriber registration for the subscriber has been rejected by that core network node, and performing said analyzing, mapping, and routing responsive to receiving that message.

3. The method according to claim 1, wherein mapping a result of said investigation to a core network node to which the subscriber registration should be routed comprises mapping a result of said investigation to a Mobile Switching Center (MSC).

4. The method according to claim 1, wherein mapping a result of said investigation to a core network node to which the subscriber registration should be routed comprises mapping a result of said investigation to a Serving GPRS Support Node (SGSN).

5. The method according to claim 1, wherein mapping a result of said investigation to a core network node to which the subscriber registration should be routed comprises mapping a result of said investigation to a core network node that supports a certain functionality required by the subscriber.

6. The method according to claim 1, wherein mapping a result of said investigation to a core network node to which the subscriber registration should be routed comprises mapping a result of said investigation to a core network node that is configured to handle machine-to-machine communication.

7. The method according to claim 1, wherein mapping a result of said investigation to a core network node to which the subscriber registration should be routed comprises mapping a result of said investigation to a core network node that is associated with a mobile virtual network operator.

8. A radio access network node for steering subscriber registrations to predefined core network nodes, wherein the radio access network node is configured to connect to a plurality of core networks, and wherein the radio access network node comprises:
an input/output section configured to receive an International Mobile Subscriber Identity (IMSI) of a subscriber in connection with establishment of a subscriber registration for said subscriber, wherein the IMSI comprises a predefined number of bits indicating a country, a network, and a Mobile Subscriber Identity Number (MSIN) of the subscriber,
a processor configured to:
analyze the IMSI by investigating the bits indicating the country and network of the subscriber and at least one of the bits indicating the MSIN, and
map a result of said investigation to a core network node to which the subscriber registration should be routed, and
a router configured to route the subscriber registration to that core network node.

9. The radio access network node according to claim 8, wherein the input/output section is further configured to receive a message from a core network node indicating that the subscriber registration for the subscriber has been rejected by that core network node, and wherein the processor is configured to perform said analyzing and said mapping responsive to receiving that message.

10. The radio access network node according to claim 8, wherein the processor is configured to map a result of said investigation to a Mobile Switching Center (MSC).

11. The radio access network node according to claim 8, wherein processor is configured to map a result of said investigation to a Serving GPRS Support Node (SGSN).

12. The radio access network node according to claim 8, wherein processor is configured to map a result of said investigation to a core network node that supports a certain functionality required by the subscriber.

13. The radio access network node according to claim 8, wherein processor is configured to map a result of said investigation to a core network node that is configured to handle machine-to-machine communication.

14. The radio access network node according to claim 8, wherein processor is configured to map a result of said investigation to a core network node that is associated with a mobile virtual network operator.

15. A method in a core network node for steering subscriber registrations to predefined core network nodes, wherein the core network node is configured to connect to a radio access network node, and wherein the method comprises:
receiving an International Mobile Subscriber Identity (IMSI) of a subscriber in connection with establishment of a subscriber registration for said subscriber, wherein the IMSI comprises a predefined number of bits indicating a country, a network, and a Mobile Subscriber Identity Number (MSIN) of the subscriber
analyzing the IMSI by investigating the bits indicating the country and network of the subscriber and at least one of the bits indicating the MSIN,
mapping the result of said investigation to an allowed core network node for the subscriber registration,
sending an accept message to the radio access network node if the said core network node is the allowed core network node, and
sending a reject message to the radio access network node if said core network node is not the allowed core network node.

16. The method according to claim 15, wherein sending a reject message comprises sending a reject message that comprises an indication that the radio network node should investigate the IMSI and map the result of that investigation to an allowed core network node.

17. A core network node for steering subscriber registrations to predefined core network nodes, wherein the core network node is configured to connect to a radio access network node, and wherein the core network node comprises:
an input/output section configured to receive an International Mobile Subscriber Identity (IMSI) of a subscriber in connection with establishment of a subscriber registration for said subscriber, wherein the IMSI comprises a predefined number of bits indicating a country, a network, and a Mobile Subscriber Identity Number (MSIN) of the subscriber, and
a processor configured to:
analyze the IMSI by investigating the bits indicating the country and network of the subscriber and at least one of the bits indicating the MSIN of the subscriber, and
map the result of said investigation to an allowed core network node for the subscriber registration, and
wherein the input/output section is further configured to
send an accept message to the radio access network node if said core network node is the allowed core network node, and
send a reject message to the radio access network node if said core network node is not the allowed core network node.

18. The core network node according to claim 17, wherein the input/output selection is configured to send a reject message that comprises an indication that the radio network node should investigate the IMSI and map the result of that investigation to an allowed core network node.
